(19) United States
(12) Patent Application Publication
(10) Pub. No.: US 2025/0232594 A1
(43) Pub. Date: Jul. 17, 2025

(54) OBJECT RECOGNITION APPARATUS

(71) Applicant: TOYOTA JIDOSHA KABUSHIKI KAISHA, Toyota-shi (JP)

(72) Inventors: Hiroki YABUSHITA, Toyota-shi (JP); Hirotaka HATAKEYAMA, Nagoya-shi (JP)

(73) Assignee: TOYOTA JIDOSHA KABUSHIKI KAISHA, Toyota-shi (JP)

(21) Appl. No.: 18/944,662

(22) Filed: Nov. 12, 2024

(30) Foreign Application Priority Data
Jan. 11, 2024 (JP) 2024-002506

(51) Int. Cl. G06V 20/58; B60Q 1/24

(52) U.S. Cl. CPC G06V 20/58; B60Q 1/249

(57) ABSTRACT

To effectively improve the recognition accuracy of the object, provided is an object recognition apparatus comprising an imaging unit for capturing front of a vehicle, an object recognition unit configured to calculate a reliability of an object recognition of an object in the image, and recognizes the object as an object actually present when the reliability is equal to or larger than a threshold value, a light control unit for controlling a light distribution of a headlamp in a light distribution pattern including an irradiation area and a light control area for shielding or dimming the irradiation light based on an existence information of the object, and a threshold change unit configured to changing, when the object in the image does not exist in the irradiation area, the threshold value to a smaller value than when the target is present in the irradiation area.

### CROSS-REFERENCE TO RELATED APPLICATION

This application claims priority to Japanese Patent Application No. JP2024-002506 filed on Jan. 11, 2024, the content of which is hereby incorporated by reference in its entirety into this application.

### BACKGROUND OF THE INVENTION

### 1. Field of the Invention

The present disclosure relates to an object recognition apparatus, and more particularly, to a technique suitable for recognition of the object in front of a vehicle.

### 2. Description of the Related Art

For example, Japanese Patent Application Laid-Open (kokai) No. 2018-078520 discloses a technique in which, in an onboard image processing apparatus, a correction threshold value of a pixel value used for image recognition processing is changed between a case where a headlamp is in a low beam state and a case where a headlamp is in a high beam state, so that appropriate object recognition can be performed even in a low beam state.

For example, in a vehicle equipped with a system that partially switches between the high beam state and the low beam state, such as an adaptive high beam system (AHS), the irradiation area of the headlamp is constantly variable in each of the high beam state and the low beam state. Therefore, as in the device described in Patent Document, only changing the correction threshold value of the pixel value based on whether the headlamp is in the low beam state or the high beam state does not appropriately perform the correction process, and there is a possibility that erroneous detection or undetected of the object may occur.

### SUMMARY OF THE INVENTION

The present disclosure discloses a technique which has been achieved so as to solve the above-described problem, and an object thereof is to effectively improve the recognition accuracy of the object.

An apparatus according to at least one embodiment of the present disclosure is an object recognition apparatus. The object recognition apparatus comprising an imaging unit for capturing an image of a predetermined area in front of a vehicle, an object recognition unit configured to calculate a reliability of an object recognition of an object in the image captured by the imaging unit, and recognizes the object as an object actually present when the calculated reliability is equal to or larger than a predetermined reliability threshold value, a light distribution control unit for controlling a light distribution of a headlamp in a light distribution pattern including an irradiation area for irradiating the irradiation light and a light control area for shielding or dimming the irradiation light by shielding or dimming a part of the irradiation light irradiated from the headlamp provided in the vehicle based on an existence information of the object exist in front of the vehicle, and a reliability threshold change unit configured to changing, when the object in the image does not exist in the irradiation area, the reliability threshold value to a smaller value than when the target is present in the irradiation area.

### BRIEF DESCRIPTION OF THE DRAWINGS

FIG. 1 is a schematic diagram showing a hardware configuration of a vehicle according to the present embodiment;

FIG. 2 is a schematic diagram showing a software configuration of a control device to the present embodiment;

FIG. 3 is a schematic diagram showing an example of a light distribution pattern of high beam light emitted from a headlamp according to the present embodiment; and

FIG. 4 is a flow chart for explaining a routine of an object recognizing process and a PCS control process according to the present embodiment.

### DESCRIPTION OF THE EMBODIMENTS

Description is now given of an object recognition apparatus according to at least one embodiment of the present disclosure with reference to the drawings.

### <Hardware Configuration>

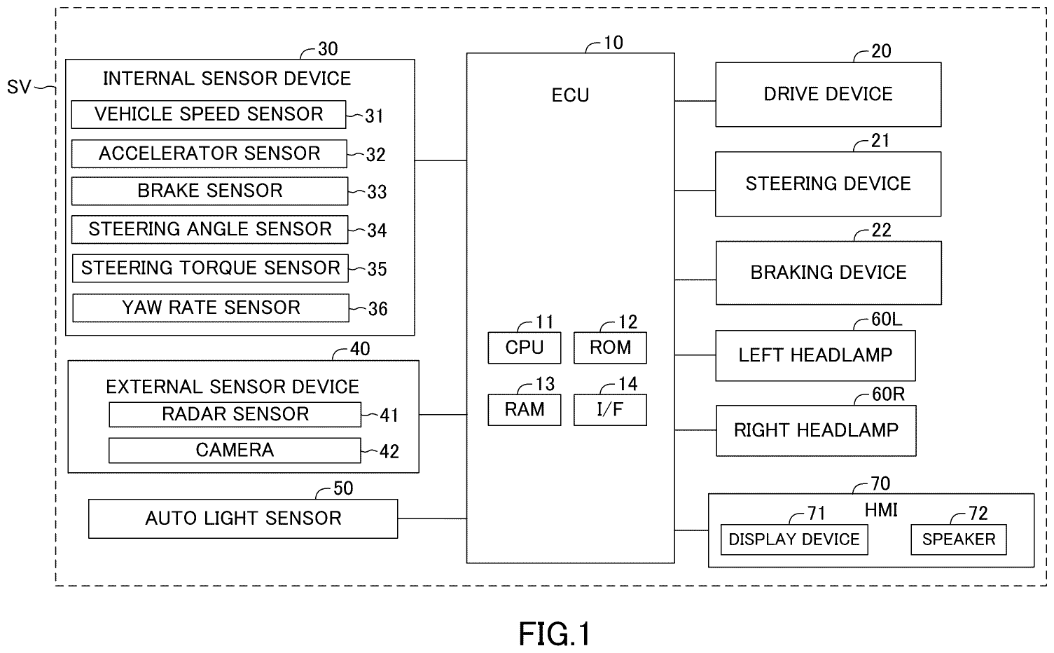

FIG. 1 is a schematic diagram of a hardware configuration of a vehicle VH according to the present embodiment. Hereinafter, the vehicle VH may be referred to as an own vehicle when it is required to distinguish it from other vehicles.

The vehicle VH has an ECU (Electronic Control Unit) 10. The ECU 10 includes a CPU (Central Processing Unit) 11, ROM (Read Only Memory) 12, RAM (Random Access Memory) 13, an interface device 14, and the like. The CPU 11 executes various programs stored in the ROM 12. The ROM 12 is a non-volatile memory that stores data and the like required for the CPU 11 to execute various programs. The RAM 13 is a volatile memory to provide a working region that is deployed when various programs are executed by the CPU 11. The interface device 14 is a communication device for communicating with an external device.

The ECU 10 is a central device which executes a driver assist control of the vehicle VH, such as a collision avoidance control (Pre-Crash Safety Control: PCS control), and the like. The driving assist control is a concept which encompasses automatic driving control. A drive device 20, a steering device 21, a braking device 22, an internal sensor device 30, an external sensor device 40, an auto light sensor 50, a left headlamp 60L, a right headlamp 60R, a HMI (Human Machine Interface) 70, and the like are communicably connected to the ECU 10.

The drive device 20 generates a driving force to be transmitted to driving wheels of the vehicle VH. As the drive device 20, for example, an engine and a motor are given. In the device according to the at least one embodiment, the vehicle VH may be any one of a hybrid electric vehicle (HEV), a plug-in hybrid electric vehicle (PHEV), a fuel cell electric vehicle (FCEV), a battery electric vehicle (BEV), and an engine vehicle. The steering device 21 applies steering forces to steerable wheels of the vehicle VH. The braking device 22 applies a braking force to the wheels of the vehicle VH.

The internal sensor device 30 is sensors which acquire states of the vehicle VH. Specifically, the internal sensor device 30 includes a vehicle speed sensor 31, an accelerator sensor 32, a brake sensor 33, a steering angle sensor 34, a steering torque sensor 35, a yaw rate sensor 36, and the like.

The vehicle speed sensor 31 detects a travel speed (vehicle speed v) of the vehicle VH. The accelerator sensor 32 detects an operation amount of an accelerator pedal (not shown) by the driver. The brake sensor 33 detects an operation amount of a brake pedal (not shown) by the driver. The steering angle sensor 34 detects a rotational angle of a steering wheel or a steering shaft (not shown) of the vehicle VH, that is, a steering angle. The steering torque sensor 35 detects a rotational torque of a steering wheel or a steering shaft (not shown) of the vehicle VH, that is, a steering torque. The yaw rate sensor 36 detects a yaw rate of the vehicle VH. The internal sensor device 30 transmits the condition of the vehicle VH detected by the sensors 31 to 36 to the ECU 10 at a predetermined cycle.

The external sensor device 40 is sensors which acquire object information on objects around the vehicle VH. Specifically, the external sensor device 40 includes a radar sensor 41, a camera 42, etc. As the object information, there are given, for example, a peripheral vehicle, a pedestrian, a traffic light, a white line of a road, a traffic sign, and the like.

The radar sensor 41 detects an object that is present around the vehicle VH. The radar sensor 41 includes a millimeter wave radar or Lidar. The millimeter wave radar radiates a radio wave (millimeter wave) in a millimeter wave band, and receives the millimeter wave (reflected wave) reflected by the object existing within a radiation range. The millimeter wave radar acquires a relative distance between the vehicle VH and the object, a relative speed between the vehicle VH and the object, and the like based on a phase difference between the transmitted millimeter wave and the received reflected wave, an attenuation level of the reflected wave, a time from the transmission of the millimeter wave to the reception of the reflected wave, and the like. The Lidar sequentially scans laser light in a pulse form having a shorter wavelength than that of the millimeter wave in a plurality of directions, and receives reflected light reflected by the object, to thereby acquire a shape of the object detected in front of the vehicle VH, the relative distance between the vehicle VH and the object, the relative speed between the vehicle VH and the object, and the like. The camera 42 is an imaging unit of the present disclosure and obtain the object information in front of the vehicle VH by capturing a region in front of the vehicle VH. As the camera 42, for example, a digital camera having an image sensor such as a CMOS or a CCD can be used. The external sensor device 40 repeatedly transmit the object information acquired by the radar sensor 41 and the camera 42 to the ECU 10 each time a predetermined time elapses.

The auto light sensor (illuminance sensor) 50 is a sensor that detects illuminance of light. The auto light sensor 50 is mounted on the vehicle VH so as to be able to detect the illuminance around the vehicle VH. The auto light sensor 50 transmits the detected illuminance information to the ECU 10 at a predetermined cycle.

The left headlamp 60L and the right headlamp 60R project irradiation light in the forward direction of the vehicle VH. Herein, “the forward direction of the vehicle VH” is a conceptual expression which encompasses not only the front direction but also an obliquely left forward direction and an obliquely right forward direction. The left headlamp 60L is provided on the left side of a front portion of the vehicle VH. The right headlamp 60R is provided on the right side of the front portion of the vehicle VH. Notably, the left headlamp 60L and the right headlamp 60R basically have the same structure; specifically, have respective structures which are mirror-images of each other. Therefore, in the following description, in the case where the left headlamp 60L and the right headlamp 60R are not required to be distinguished from each other, the left headlamp 60L and the right headlamp 60R may be referred to simply as the “headlamp 60.” Also, as to the low beam (headlamp for passing each other) provided in the headlamp 60, description is omitted.

The headlamp 60 includes a low beam headlamp and a high beam headlamp. The low beam headlamp irradiates a front area of the vehicle VH with the low beam irradiation light. The high beam headlamp irradiates the high beam irradiation light to an area wider than the low beam irradiation light toward the front area of the vehicle VH. The headlamp 60 is turned on or off in response to an instruction signal transmitted from the ECU 10 in response to an operation of an operating device (not shown) by the driver. Further, when the operating device (not shown) is operated to the automated position, the headlamp 60 is turned on or off in response to an instruction signal transmitted from the ECU 10 based on the illuminance information acquired by the auto light sensor 50.

The headlamp 60 is the headlamp corresponding to the AHS, and has a function of shielding a part of an irradiated area by high beam irradiation in accordance with a position of a light control target object (for example, a preceding vehicle, an oncoming vehicle, a pedestrian, a sign, or the like) acquired by the external sensor device 40. Notably, in the present disclosure, “shielding of irradiation light” is a conceptual expression which “dimming of irradiation light” encompasses. Examples of the headlamp having such a function include a headlamp including a plurality of LED (Light Emitting Diode) arranged in a matrix shape, a headlamp including a DMD (Digital Mirror Device) constituted by a plurality of micro-mirror elements arranged in a matrix shape, and a headlamp including a MEMS (Micro Electro Mechanical Systems) mirror. Since the configuration of these headlamps is known, detailed description thereof will be omitted.

The HMI 70 is an interface for inputting and outputting data between the ECU 10 and the driver, and includes an input device and an output device. Examples of the input device include a touch panel, a switch, and a sound pickup microphone. Examples of the output device include a display device 71 and a speaker 72. The display device 71 is, for example, a center display installed in an instrument panel or the like, a multi-information display, a head-up display, or the like. The speaker 72 is, for example, a speaker of an acoustic system or the navigation system.

### <Software Configuration>

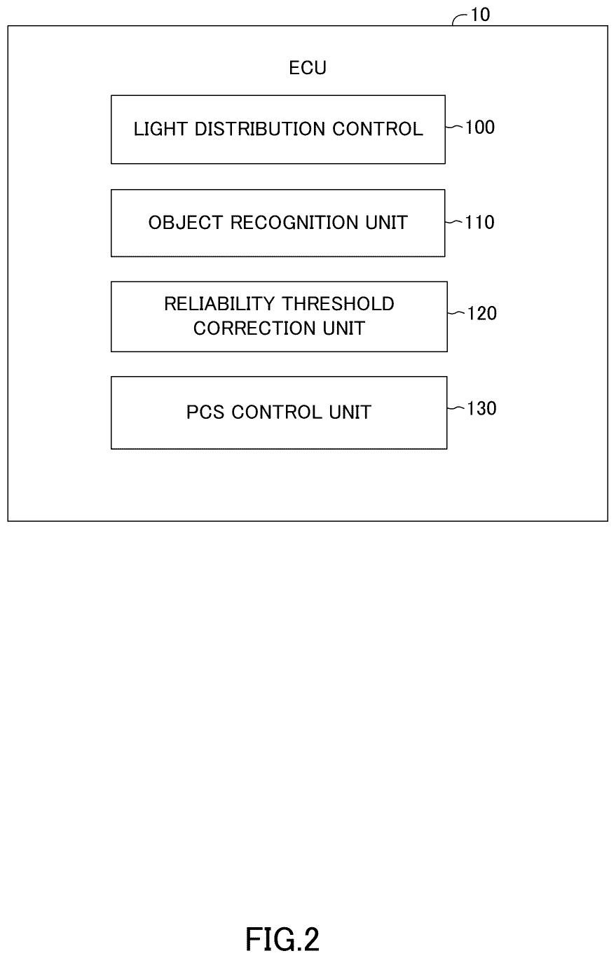

FIG. 2 is a schematic diagram showing a software configuration of the ECU 10 to the present embodiment. As shown in FIG. 2, the ECU 10 includes a light distribution control unit 100, an object recognition unit 110, a reliability threshold correction unit 120, a PCS control unit 130, and the like as a part of functional elements. The CPU 11 of the ECU 10 realizes each of these functional elements 100 to 130 by reading a program stored in the ROM 12, loading the read program into the RAM 13, and executing the loaded program. Notably, that all or a part of the functional elements 100 to 130 may be provided in another ECU separate from the ECU 10 or in an information processing device of a facility (a control center or the like) capable of communicating with the vehicle VH.

The light distribution control unit 100 executes a light distribution control to acquire the position of the light control target object on the basis of the detection result of the external sensor device 40, and to shield or dim a part of the irradiation area by the high beam irradiation according to the acquired position of the light control target object. Examples of the light control target object include the preceding vehicle, an oncoming vehicle, a pedestrian's face, and the road sign. When the position of the preceding vehicle or the oncoming vehicle and the position of the face of the pedestrian are shielded or dimmed, it is possible to prevent the driver of the preceding vehicle or the oncoming vehicle and the pedestrian from being glared by glare. Further, if the position of the retroreflective object such as the road sign is shielded or dimmed, it is possible to prevent the drivers of the own vehicle VH from being glared by the reflected light from the retroreflective object.

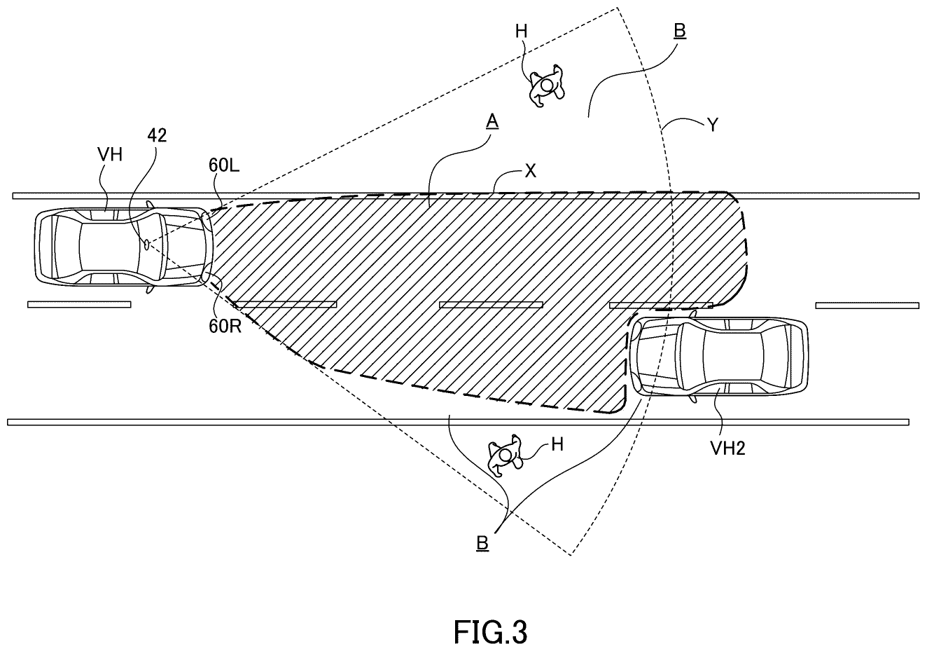

FIG. 3 is an example of a light distribution pattern of high beam irradiation light emitted from the headlamp 60. The light distribution pattern illustrated in FIG. 3 is a combination of the left side headlamp 60L and the right side headlamp 60R. The region surrounded by the broken line X in FIG. 3 indicates the irradiation area by the high beam irradiation of the headlamp 60. The region surrounded by the broken line Y in FIG. 3 is an example of the imaging area of the camera 42. When, for example, the oncoming vehicle VH2 is acquired as the light control target object on the basis of the detection result of the external sensor device 40, the light distribution control unit 100 causes the headlight 60 to emit high beam irradiation of a light distribution pattern in which an area corresponding to the position of the oncoming vehicle VH2 is shielded or dimmed. Hereinafter, an area irradiated with a high beam by the headlamp 60 is referred to as a “headlamp irradiation area A”. In addition, an area where the high beam is not irradiated by the headlamp 60 (including a shaded or dimmed are) is referred to as a “headlamp non-irradiation area B”.

The object recognition unit 110 recognizes the object present in front of the vehicle VH based on images transmitted from the cameras 42 of the external sensor device 40. Specifically, the object recognizing unit 110 computes a reliability DR of the object based on the sharpness of the object outline included in the image data captured by the camera 42, the degree of coincidence with the feature point of the registered image pattern, or the like. The reliability DR is an index indicating the accuracy with which the object is actually present. When the reliability DR is small, the possibility that the object is actually present is low, and when the reliability DR is large, the possibility that the object is actually present is high. When the calculated reliability DR is equal to or greater than the predetermined reliability threshold DRV (DR=DRV), the object recognition unit 110 recognizes the object included in the image data as the object actually present.

Incidentally, the object (reference numerals VH2, H in FIG. 3) existing in the headlamp non-irradiation area B tends to have a lower reliability DR than the object existing in the headlamp irradiation area A. Therefore, if the reliability thresholds DRV are set to a uniform fixed value, there is a possibility that the object recognition unit 110 may not recognize the object actually present in the headlamp non-irradiation area B, resulting in erroneous detection or undetected.

The reliability threshold correction unit 120 executes threshold correction for correcting the reliability threshold DRV in order to prevent erroneous detection or undetected of the object existing in the headlamp non-irradiation area B. The reliability threshold correction unit 120 is a reliability threshold change unit of the present disclosure. The reliability threshold correction unit 120 specifies the headlamp irradiation area A by the headlamp 60 from the image data of the camera 42 based on the information of the light t distribution control by the light distribution control unit 100. When specifying the headlamp irradiation area A, the reliability threshold correction unit 120 determines whether or not the object in the image data is present in the headlamp irradiation area A. The reliability threshold correction unit 120 does not executes the threshold correction when it is determined that the object is present in the headlamp irradiation area A.

On the other hand, the reliability threshold correction unit 120 executes the threshold correction when it is determined that the object is not present in the headlamp irradiation area A, that is, when the object in the image data is present in the headlamp non-irradiation area B. The reliability threshold correction unit 120 executes the threshold correction by multiplying the reliability threshold DRv by a predetermined gain factor k. Hereinafter, the correction reliability threshold (=DRv×k) is referred to as “corrected reliability threshold DRv′”. The gain factor k is a numerical value equal to or greater than 0 and less than 1 (0≤k<1). That is, the corrected reliability threshold DRv′ is smaller than the reliability threshold DRv. As described above, when the object in the image data exists in the headlamp non-irradiation are B, the object recognition unit 110 corrections the threshold used for the determination of the object recognition to the corrected reliability threshold DRv′ smaller than the reliability threshold DRV, thereby effectively preventing undetected or erroneous detection of the object existing in the headlamp non-irradiation area B. The gain factor k may be a fixed value or may be a variable value corresponding to the illuminance detected by the auto light sensor 50.

The PCS control unit 130 is one example of a collision avoidance control unit of the present disclosure and executes the PCS control for avoiding collision between the own vehicle VH and the front object or reducing damage to the collision. The PCS control unit 130 determines whether or not the object to be subjected to PCS control (hereinafter referred to as a target object) exists in front of the own vehicle VH based on the object information recognized by the object recognition unit 110. When it is determined that the target object is present, the PCS control unit 130 acquires the coordinate information of the target object based on the detection result of the external sensor device 40. Further, the PCS control unit 130 calculates the turning radius of the vehicle VH based on the detection results of the vehicle speed sensor 31, the steering angle sensor 34, and the yaw rate sensor 36, and calculates the trajectory of the vehicle VH based on the turning radius. The PCS control unit 130 determines whether the target object in front of the own vehicle VH is obstacle that may collide with the vehicle VH. When the target object is a moving object, the PCS control unit 130 determines the moving object as an obstacle, when the trajectory of the moving object and the trajectory of the vehicle VH intersect each other. When the target object is a stationary object, the PCS control unit 130 determines that the stationary object is an obstacle when the trajectory of the vehicle VH intersects the present position of the stationary object.

When the PCS control unit 130 determines that the target object is the obstacle, the PCS control unit 130 calculates a predicted collision time (Time To Collision: TTC) until the vehicle VH collides with the obstacle based on the distance L from the vehicle SV to the obstacle and the relative velocity Vr of the vehicle VH with respect to the obstacle. TTC is an index indicating a possibility that the vehicle VH collides with the obstacle. TTC can be determined by dividing the distance L from own vehicle SV to the obstacle by the relative velocity Vr (TTC=L/Vr). The PCS control unit 130 determines that the vehicle VH is highly likely to collide with the obstacle when the state in which TTC is equal to or smaller than the predetermined collision determination threshold Tv. In the present embodiment, when the target object exists in the headlamp non-irradiation area B, the object recognition unit 110 recognizes the presence of the target object on the basis of the corrected reliability threshold DRv′ smaller than the reliability threshold DRv. That is, even when the obstacle to be subjected to the PCS control exists in the headlight non-irradiation area B, the obstacle can be effectively prevented from being non-detected or erroneously detected. Accordingly, the accuracy of the collision determination of the PCS control can be reliably improved.

When determining that there is a high possibility of collision, the PCS control unit 130 executes an alarm by the speaker 72 or the display device 71, and also executes an automated braking control. The automated braking control is a control for reducing the own vehicle VH so that the deceleration of the own vehicle VH coincides with a predetermined target deceleration by controlling the activation of the braking device 22 and/or the driving device 20. Accordingly, the own vehicle VH can be forcibly decelerated without requiring the driver to operate the brake pedal.

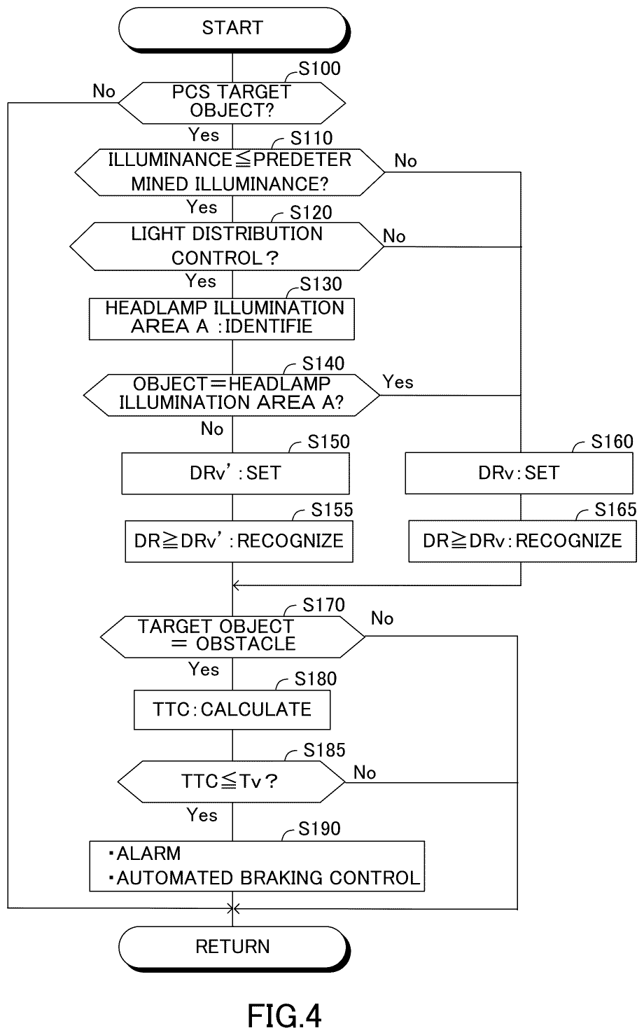

Next, a routine of the object recognition process and the PCS control process by the CPU 11 of the ECU 10 will be described with reference to FIG. 4. This routine is started when the vehicle VH travels.

In step S100, the ECU 10 determines whether or not the target object of the PCS control exists in front of the own vehicle VH based on the detection result of the external sensor device 40. If there is the target object (Yes), the ECU 10 advances the process to step S110. On the other hand, if the target object does not exist (No), the ECU 10 returns this routine.

In step S110, the ECU 10 determines whether or not the illuminance around the own vehicle VH is equal to or less than the predetermined illuminance based on the illuminance information acquired by the auto light sensor 50. When the illuminance around the vehicle VH is equal to or less than the predetermined illuminance (Yes), that is, in the dark place, the ECU 10 advances the process to step S120. On the other hand, when the illuminance around the vehicle VH is not equal to or less than the predetermined illuminance (No), that is, when the illuminance is bright, the ECU 10 advances the process to step S160.

In step S120, the ECU 10 determines whether or not the light distribution control of the headlamp 60 is being executed. When the light distribution control is being executed (Yes), the ECU 10 advances the process to step S130. On the other hand, when the light distribution control is not being executed (No), the ECU10 advances the process to step S160.

In step S130, the ECU 10 identifies the headlamp illumination area A by the headlamp 60. Next, in the step S140, the ECU 10 determines whether or not the target object is present in the headlamp illumination area A. If the target object is present in the headlamp illumination area A (Yes), the ECU 10 advances the process to step S160. On the other hand, if the target object is not present in the headlamp irradiation area A (No), that is, when the target object is present in the headlamp non-irradiation area B, the ECU 10 advances the process to step S150.

In step S150, the ECU 10 corrects the reliability threshold DRv to set the threshold used for the determination of the target object recognition to the corrected reliability threshold DRv′. Next, in step S155, the ECU 10 recognizes the object as the target object of the PCS control, whose reliability DR is equal to or larger than the corrected reliability thresholds DRv′.

In step S160 proceed from step S110 or step S120 or step S140, the ECU 10 sets the threshold used for determining the target object recognition to the normal reliability threshold DRv. Next, in the step S165, the ECU 10 recognizes the object as the target of the PCS control, whose reliability DR is equal to or larger than the reliability thresholds DRV.

In step S170, the ECU 10 determines whether or not the target object recognized in step S155 and/or step S165 process is the obstacle. When the target object is the moving object, the ECU 10 determines the target object as the obstacle when the trajectory of the target object and the trajectory of the own vehicle VH intersect each other. When the target object is the stationary object, the ECU 10 determines that the target object is the obstacle when the trajectory of the own vehicle VH intersects the present position of the target object. When determining that the target object is the obstacle (Yes), the ECU 10 advances the process to step S180. On the other hand, if the ECU 10 determines that the target object in front of the own vehicle VH is not the obstacle (No), the ECU 10 returns this routine.

In step S180, the ECU 10 calculates the TTC (=L/vr) by dividing the distance L from the own vehicle VH to the target object by the relative velocity Vr. Then, in step S185, the ECU 10 determines whether the TTC is less than or equal to the collision determination thresholds Tv. If the TTC is less than or equal to the collision determination threshold Tv (Yes), the ECU 10 advances the process to step S190. On the other hand, if the TTC is greater than the collision determination threshold Tv (No), the ECU 10 returns this routine.

In step S190, the ECU 10 executes the alarm and the automated braking control to decelerate the own vehicle VH based on the predetermined target deceleration, and returns this routine.

In the above, the object recognition apparatus according to the at least one embodiment have been described, but the present disclosure is not limited to the above-mentioned at least one embodiment, and various modifications are possible within the range not departing from the object of the present disclosure.

For example, in the above embodiment, the object recognized by the object recognition unit 110 is described as being applied to the PCS control, but it can also be applied to other driving assist control such as an adaptive cruise control (ACC) and a lane trace assist control (LTA). Further, the application of the present disclosure can also be applied to the vehicle that automatically performs some or all of the driving operations.

What is claimed is:

1. An object recognition apparatus comprising:
an imaging unit for capturing an image of a predetermined area in front of a vehicle;
an object recognition unit configured to calculate a reliability of an object recognition of an object in the image captured by the imaging unit, and recognizes the object as an object actually present when the calculated reliability is equal to or larger than a predetermined reliability threshold value;
a light distribution control unit for controlling a light distribution of a headlamp in a light distribution pattern including an irradiation area for irradiating the irradiation light and a light control area for shielding or dimming the irradiation light by shielding or dimming a part of the irradiation light irradiated from the headlamp provided in the vehicle based on an existence information of the object exist in front of the vehicle; and
a reliability threshold change unit configured to changing, when the object in the image does not exist in the irradiation area, the reliability threshold value to a smaller value than when the target is present in the irradiation area.

2. The object recognition apparatus according to claim 1,
wherein the reliability threshold change unit is configured to changes the reliability threshold value to a small value by multiplying the reliability threshold value by a gain factor of 0 or more and less than 1, when the object in the image does not exist in the irradiation region.

3. The vehicle control device according to claim 1,
wherein the vehicle comprising a collision avoidance control unit configured to execute a collision avoidance control for avoiding a collision between the vehicle and the object or reducing the damage of the collision when the object recognized in front of the vehicle satisfies a predetermined collision condition; and
wherein the object recognition unit causes the collision avoidance control unit to recognize the object by transmitting an information of the recognized object to the collision avoidance control unit.
